(19) United States
(12) Patent Application Publication
(10) Pub. No.: US 2022/0366574 A1
(43) Pub. Date: Nov. 17, 2022

(54) IMAGE-CAPTURING APPARATUS, IMAGE PROCESSING SYSTEM, IMAGE PROCESSING METHOD, AND PROGRAM

(71) Applicant: SONY GROUP CORPORATION, TOKYO (JP)

(72) Inventor: MANABU KAWASHIMA, TOKYO (JP)

(21) Appl. No.: 17/753,865

(22) PCT Filed: Aug. 5, 2020
(86) PCT No.: PCT/JP2020/030040

§ 371 Date: Mar. 16, 2022

(30) Foreign Application Priority Data
Sep. 26, 2019 (JP) 2019-175935

(51) Int. Cl. G06T 7/246; G06V 10/25; G06T 7/73

(52) U.S. Cl. CPC G06T 7/246; G06V 10/25; G06T 7/73

(57) ABSTRACT

To provide an image-capturing apparatus, an image processing system, an image processing method, and a program that make it possible to prevent a moving object from being detected in image information. An image-capturing apparatus according to the present technology includes an image processing circuit. The image processing circuit detects feature points for respective images of a plurality of images captured at a specified frame rate, and performs processing of calculating a moving-object weight of the detected feature point a plurality of times.

### TECHNICAL FIELD

The present technology relates to an image-capturing apparatus, an image processing system, an image processing method, and a program.

### BACKGROUND ART

Simultaneous localization and mapping (SLAM) that estimates a self-location and creates an environment map at the same time is adopted as a technology that estimates a self-location and a pose of, for example, a camera or an autonomous vacuum cleaner (for example, Patent Literature 1), and a method using an inertial measurement unit (IMU) is often proposed. However, in a system that primarily uses an IMU in order to estimate a self-location and a pose of an object using SLAM, observation noise is accumulated in process of performing integration processing on an acceleration and an angular velocity that are detected by the IMU, and the reliability of sensor data that is output by the IMU is ensured only for a short period of time. This may result in being unpractical.

Thus, a technology called visual inertial odometry (VIO) has been proposed in recent years, the visual inertial odometry estimating a self-location and a pose of an object with a high degree of accuracy by fusing odometry information and visual odometry, the odometry information being obtained by performing integration processing on an acceleration and an angular velocity that are detected by an IMU, the visual odometry tracking a feature point in an image captured by the object and estimating an amount of movement of the object using a projective geometry approach.

### CITATION LIST

### Patent Literature

Patent Literature 1: Japanese Patent Application Laid-open No. 2017-162457

### DISCLOSURE OF INVENTION

### Technical Problem

In a technology such as the visual inertial odometry described above, a long exposure time makes it more difficult to detect a feature point due to a movement blur caused by the movement of a camera, and this may result in reducing the estimation accuracy. For the purpose of preventing such a reduction in estimation accuracy, the exposure time of a camera is generally limited to being short in order to prevent a feature point from being erroneously detected in an image captured by an object due to a movement blur caused by a camera. However, even in such a case, the estimation accuracy upon estimating a self-location and a pose of an object may be reduced if a large number of moving objects is detected in an image captured by the object.

Thus, the present disclosure proposes an image-capturing apparatus, an image processing system, an image processing method, and a program that make it possible to prevent a moving object from being detected in image information.

### Solution to Problem

In order to achieve the object described above, an image-capturing apparatus according to an embodiment of the present technology includes an image processing circuit.

The image processing circuit detects feature points for respective images of a plurality of images captured at a specified frame rate, and performs processing of calculating a moving-object weight of the detected feature point a plurality of times.

The image processing circuit may perform processing of extracting an image patch that is situated around the detected future point for each of the plurality of images.

The image processing circuit may perform first matching processing that includes searching for a region in a current frame of each of the plurality of images, the region corresponding to the image patch, and detecting, in the region, a feature point that corresponds to the feature point detected for each of the plurality of images.

The image processing circuit may acquire sensor data that is obtained by an acceleration and an angular velocity of a detector being detected by the detector, may perform integration processing on the sensor data to calculate a location and a pose of an image-capturing section that captures the plurality of images, and may calculate a prediction location, in the current frame, at which the detected feature point is situated, on the basis of location information regarding a location of the detected feature point and on the basis of the calculated location and pose.

On the basis of the feature point detected by the first matching processing, and on the basis of the prediction location, the image processing circuit calculates a moving-object weight of the feature point detected by the first matching processing.

The image processing circuit may calculate a distance between the feature point detected by the first matching processing and the prediction location, and may calculate the moving-object weight from the calculated distance.

The image processing circuit may repeatedly calculate the moving-object weight for the feature point detected by the first matching processing, and may calculate an integration weight obtained by summing the moving-object weights obtained by the repeated calculation.

The image processing circuit may perform processing that includes detecting a feature point in each of the plurality of images at a specified processing rate, and extracting an image patch that is situated around the feature point, and may perform second matching processing at the specified processing rate, the second matching processing including searching for a region in a current frame of each of the plurality of images, the region corresponding to the image patch, and detecting, in the region, a feature point that corresponds to the feature point detected at the specified processing rate.

On the basis of the integration weight, the image processing circuit may sample the feature points detected by the second matching processing.

In order to achieve the object described above, an image processing system according to an embodiment of the present technology includes an image-capturing apparatus.

The image-capturing apparatus includes an image processing circuit.

The image processing circuit detects feature points for respective images of a plurality of images captured at a specified frame rate, and performs processing of calculating a moving-object weight of the detected feature point a plurality of times.

In order to achieve the object described above, an image processing method according to an embodiment of the present technology that is performed by an image processing circuit includes detecting feature points for respective images of a plurality of images captured at a specified frame rate; and performing processing of calculating a moving-object weight of the detected feature point a plurality of times.

In order to achieve the object described above, a program according to an embodiment of the present technology causes an image processing circuit to perform a process including detecting feature points for respective images of a plurality of images captured at a specified frame rate, and performing processing of calculating a moving-object weight of the detected feature point a plurality of times.

### BRIEF DESCRIPTION OF DRAWINGS

FIG. 1 is a block diagram illustrating an example of a configuration of an image processing system according to the present embodiment.

FIG. 2 is a block diagram illustrating another example of the configuration of the image processing system.

FIG. 3 is a block diagram illustrating another example of a configuration of an image-capturing apparatus according to the present embodiment.

FIG. 4 is a flowchart illustrating a typical flow of an operation of the image processing system.

FIG. 5 schematically illustrates both a previous frame and a current frame.

FIG. 6 schematically illustrates both a previous frame and a current frame.

FIG. 7 is a conceptual diagram illustrating both a normal exposure state and an exposure state of the present technology.

### MODE(S) FOR CARRYING OUT THE INVENTION

Embodiments of the present technology will now be described below with reference to the drawings.

### Configuration Of Image Processing System

### First Configuration Example

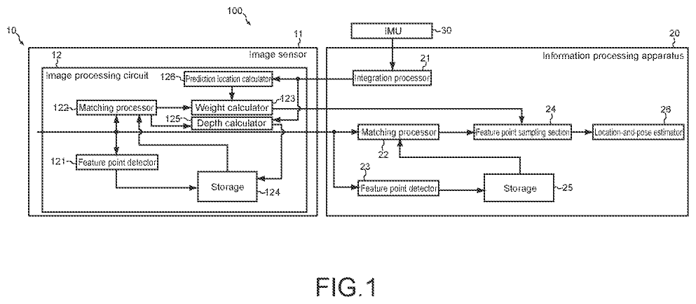

FIG. 1 is a block diagram illustrating an example of a configuration of an image processing system 100 according to the present embodiment. The image processing system 100 includes an image-capturing apparatus 10, an information processing apparatus 20, and an IMU 30.

(Image-Capturing Apparatus)

As illustrated in FIG. 1, the image-capturing apparatus 10 includes an image sensor 11. The image-capturing apparatus 10 captures an image of a real space using the image sensor 11 and various members such as a lens used to control the formation of an image of a subject on the image sensor 11, and generates a captured image.

The image-capturing apparatus 10 may capture a still image at a specified frame rate, or may capture a moving image at a specified frame rate. The image-capturing apparatus 10 can capture an image of a real space at a specified frame rate (for example, 240 fps). In the following description, an image captured at a specified frame rate (for example, 240 fps) is defined as a high-speed image.

The image sensor 11 is an imaging device such as a charge-coupled device (CCD) sensor or a complementary metal-oxide semiconductor (CMOS) sensor. The image sensor 11 internally includes an image processing circuit 12. The image-capturing apparatus 10 is a tracking device such as a tracking camera, and the image sensor 11 is included in any of the devices as described above.

The image processing circuit 12 is a computation processing circuit that controls an image captured by the image-capturing apparatus 10, and performs specified signal processing. The image processing circuit 12 may include a CPU that controls the entirety of or a portion of an operation of the image-capturing apparatus 10 according to various programs recorded in, for example, a read only memory (ROM) or a random access memory (RAM).

Further, instead of, or in addition to the CPU, the image processing circuit 12 may include a processing circuit such as a digital signal processor (DSP), an application-specific integrated circuit (ASIC), a field-programmable gate array (FPGA), a simple programmable logic device (SPLD), or a graphics processing unit (GPU).

The image processing circuit 12 functionally includes a feature point detector 121, a matching processor 122, a weight calculator 123, a storage 124, a depth calculator 125, and a prediction location calculator 126.

The feature point detector 121 detects a feature point for each high-speed image, and writes an image patch situated around the feature point into the storage 124. For example, the feature point is a point that indicates a boundary between different regions of which at least one of the brightness, a color, or a distance exhibits a value greater than or equal to a specified value, and corresponds to, for example, an edge (a point at which there is a sharp change in brightness), or a corner (a black point of a line or a portion of a steeply turned edge).

The feature point detector 121 detects a feature point from in a high-speed image using image processing performed according to a specified algorithm such as scale invariant feature transform (SIFT), speed-up robust features (SURF), rotation invariant fast features (RIFF), binary robust independent elementary features (BRIEF), binary robust invariant scalable keypoints (BRISK), oriented FAST and rotated BRIEF (ORB), and compact and real-time descriptors (CARD). The feature point described below refers to a feature point detected using such an algorithm.

The matching processor 122 performs matching processing of searching for a region in a high-speed image, the region corresponding to an image patch situated around a feature point. The matching processor 122 reads the image patch from the storage 124.

On the basis of a feature point detected by the matching processor 122 and a prediction location calculated by the prediction location calculator 126, the weight calculator 123 calculates a moving-object weight of the feature point. Likewise, the weight calculator 123 calculates moving-object weights for respective images captured at a high-speed frame rate, and integrates these weights to calculate an integration weight used as a priority reference when sampling is performed by a feature point sampling section 24 described later.

The storage 124 stores therein an image patch situated around a feature point that is extracted from a high-speed image. The image patch is a partial region, in an image, that corresponds to a unit of image analysis, and is a region with, for example, sides of 256 pixels or 128 pixels. The same applies to the following description.

The depth calculator 125 calculates a depth of a feature point detected by the feature point detector 121. The depth of a feature point is a depth of a three-dimensional feature-point location from a camera coordinate system in the past, and is calculated using Formula (7) indicated below, which will be described later.

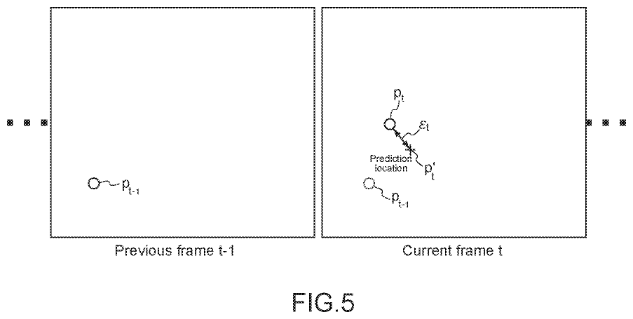

On the basis of a relative location and a relative pose of the image-capturing apparatus 10, the prediction location calculator 126 calculates a prediction location (refer to FIG. 5), in a current frame of a high-speed image, at which a feature point detected in a previous frame of the high-speed image is situated. Note that the current frame is an image that is from among images consecutively captured by the image-capturing apparatus 10 at a specified frame rate and on which processing is being performed by the image processing system 100 (the image processing circuit 12), whereas the previous frame is an image on which the processing has been already performed. The same applies to the following description.

Further, the image processing circuit 12 may include a ROM, a RAM, and a communication apparatus (not illustrated). The ROM stores therein a program and a computation parameter that are used by a CPU. The RAM primarily stores therein, for example, a program used when the CPU 110 performs processing, and a parameter that varies as necessary during the processing. The storage 124 may be the ROM or the RAM described above.

The communication apparatus is, for example, a communication interface that includes, for example, a communication device used to establish a connection with a network that is used to connect the image processing circuit 12 and the information processing apparatus 20. The communication apparatus may be, for example, a communication card for a local area network (LAN), Bluetooth (registered trademark), Wi-Fi, or a Wireless USB (WUSB).

Further, the network connected to the communication apparatus is a network connected by wire or wirelessly, and examples of the network may include the Internet, a home LAN, an infrared communication, a radio wave communication, and a satellite communication. Furthermore, the network may be, for example, the Internet, a mobile communication network, or a local area network, or the network may be a network obtained by combining a plurality of the above-described types of networks.

(Information Processing Apparatus)

The information processing apparatus 20 includes hardware, such as a central processing unit (CPU), a random access memory (RAM), and a read only memory (ROM), that is necessary for a computer. An operation in the information processing apparatus 20 is performed by the CPU loading, into the RAM, a program according to the present technology that is recorded in, for example, the ROM in advance and executing the program.

The information processing apparatus 20 may be a server or any other computer such as a PC. The information processing apparatus 20 functionally includes an integration processor 21, a matching processor 22, the feature point sampling section 24, a storage 25, and a location-and-pose estimator 26.

The integration processor 21 performs integration processing on sensor data (an acceleration and an angular velocity) measured by the IMU 30, and calculates a relative location and a relative pose of the image-capturing apparatus 10.

The matching processor 122 performs matching processing of searching for a region in a current frame of a high-speed image at a specified processing rate (the processing rate of the image processing system 100), the region corresponding to an image patch situated around a feature point.

The matching processor 122 performs matching processing of searching for a region in an image (hereinafter referred to as a normal image) that is output from the image sensor 11 at a specified output rate (the processing rate of the image processing system 100), the region corresponding to an image patch situated around a feature point. The matching processor 22 reads the image patch from the storage 25.

The feature point detector 23 detects a feature point in a high-speed image at a specified processing rate (the processing rate of the image processing system 100), extracts an image patch situated around the feature point, and writes the image patch into the storage 25.

For each normal image, the feature point detector 23 detects a feature point, and writes an image patch situated around the feature point into the storage 25. The feature point sampling section 24 samples feature points detected by the matching processor 22 on the basis of an integration weight calculated by the weight calculator 123.

The storage 25 stores therein an image patch situated around a feature point that is extracted from a normal image. The storage 25 may be a storage apparatus such as a RAM or a ROM. The location-and-pose estimator 26 estimates a location and a pose of the image-capturing apparatus 10 including the image sensor 11, using an amount of an offset between feature points sampled by the feature point sampling section 24.

(IMU)

The IMU 30 is an inertial measurement unit in which, for example, a gyroscope, an acceleration sensor, a magnetic sensor, and a pressure sensor are combined on a plurality of axes. The IMU 30 detects its own acceleration and angular velocity, and outputs sensor data obtained by the detection to the integration processor 21. For example, a mechanical IMU, a laser IMU, or an optical fiber IMU may be adopted as the IMU 30, and the type of the IMU 30 is not limited.

Where the IMU 30 is placed in the image processing system 100 is not particularly limited, and, for example, the IMU 30 may be included in the image sensor 11. In this case, the image processing circuit 12 may convert the acceleration and angular velocity acquired from the IMU 30 into an acceleration and an angular velocity of the image-capturing apparatus 10, on the basis of a relationship in location and pose between the image-capturing apparatus 10 and the IMU 30.

### Second Configuration Example

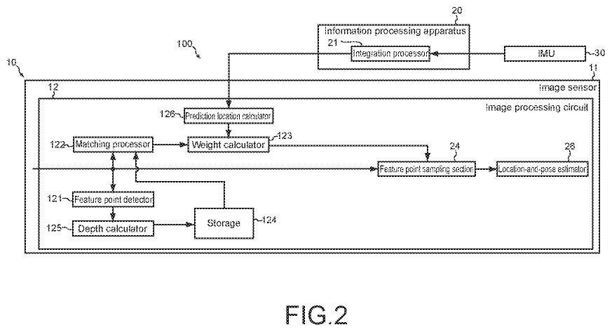

FIG. 2 is a block diagram illustrating another example of the configuration of the image processing system 100 according to the present embodiment. As illustrated in FIG. 2, the image processing system 100 may have a configuration in which the image processing circuit 12 includes the feature point sampling section 24 and the location-and-pose estimator 26. Note that, in a second configuration example, a structural element that is similar to the structural element in the first configuration example is denoted by a reference numeral similar to the reference numeral used in the first configuration example, and a description thereof is omitted.

### Third Configuration Example

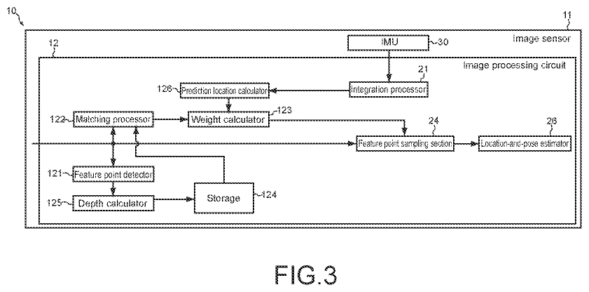

FIG. 3 is a block diagram illustrating another example of a configuration of the image-capturing apparatus 10 according to the present embodiment. As illustrated in FIG. 3, the image-capturing apparatus 10 of the present technology may include the IMU 30 and the image processing circuit 12, and may have a configuration in which the image processing circuit 12 includes the integration processor 21, the feature point sampling section 24, and the location-and-pose estimator 26. Note that, in a third configuration example, a structural element that is similar to the structural element in the first configuration example is denoted by a reference numeral similar to the reference numeral used in the first configuration example, and a description thereof is omitted.

The examples of the configuration of the image processing system 100 have been described above. Each of the structural elements described above may be configured using a general-purpose member, or using hardware specialized for a function of the structural element. The configuration may be modified as appropriate according to a technical level that is necessary every time the present technology is implemented.

<Image Processing Method>

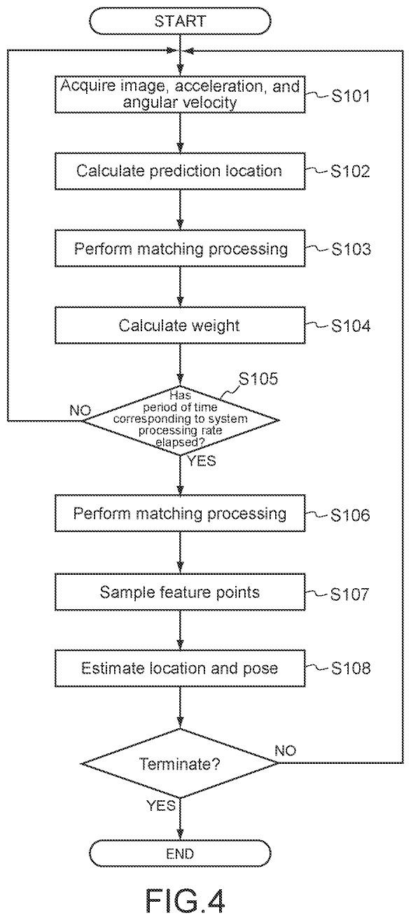

FIG. 4 is a flowchart illustrating a typical flow of an operation of the image processing system 100. According to the present technology, image information that is discarded when the processing rate of the image processing system 100 is adopted is effectively used to prevent a moving object from being detected in an image. This results in improving the robustness. Referring to FIG. 4 as appropriate, an image processing method performed by the image processing system 100 is described below.

[Step S101: Acquisition of Image, Acceleration, and Angular Velocity]

The feature point detector 121 acquires a high-speed image from the image sensor 11. The feature point detector 121 detects a feature point in the high-speed image, and outputs location information regarding a location of the feature point to the storage 124. The feature point detector 121 extracts, from the high-speed image, the feature point and an image patch situated around the feature point, and writes the image patch into the storage 124.

The integration processor 21 acquires, from the IMU 30, sensor data regarding an acceleration and an angular velocity that are detected by the IMU 30, and performs integration processing on the acceleration and the angular velocity to calculate amounts of changes in a relative location and a relative pose per unit of time, the relative location and the relative pose being a relative location and a relative pose of the image-capturing apparatus 10 including the image sensor 11. The integration processor 21 outputs a result of the calculation to the prediction location calculator 126.

Specifically, when the integration processor 21 calculates, from an IMU integration value, amounts of changes in a relative location and a relative pose per unit of time, the integration processor 21 calculates an amount ΔP of a change in relative location per unit of time and an amount ΔR of a change in relative pose per unit of time using, for example, Formulas (1) to (3) indicated below, where an acceleration, an angular velocity, an acceleration bias, an angular velocity bias, a gravitational acceleration, and a change in time are respectively represented by aₘ, ωₘ, bₐ, b_{w}, g, and Δt.

[Math. 1]

[symbol]

P=Vₜ [symbol] t+Rₜ∫∫ [symbol] R(aₘₜ−bₐₜ)dtdτ+½g [symbol] t² (1)

$$q = ( \begin{matrix}\frac{\overline{ω}}{\vert \overline{ω} \vert} sin ( \frac{1}{2} \vert \overline{ω} \vert t ) + \frac{{t}^{2}}{24} {ω}_{t} ⨯ {ω}_{t + 1} \\ cos ( \frac{1}{2} \vert \overline{ω} \vert t )\end{matrix} ) , \\ \overline{ω} = \frac{1}{2} {( {ω}_{t + 1} + {ω}_{t} )}_{,} ω = {ω}_{m} - {b}_{w} \qquad ( 2 )$$

[Math. 3]

[symbol]

R=I+2q_{w}qₓ2(qₓ)², [symbol] q=(q^{T}q_{w})^{T} (3)

[Step S102: Calculation of Prediction Location]

On the basis of the amount ΔP of a change in relative location and the amount ΔR of a change in relative pose, which are acquired from the integration processor 21, and on the basis of location information regarding a location of a feature point and a depth of the feature point that are stored in the storage 124, the prediction location calculator 126 calculates a prediction location p′ₘ, in a current frame, at which the feature point is situated, and outputs a result of the calculation to the weight calculator 123.

Specifically, the prediction location calculator 126 calculates two-dimensional coordinates of the prediction location p′ₜ using, for example, Formulas (4) to (6) indicated below, where two-dimensional coordinates of a feature point detected in a previous frame is represented by pₜ₋₁, a location of three-dimensional coordinates of the feature point is represented by Pₜ₋₁, a predicted location of three-dimensional coordinates of the feature point is represented by Pₜ, a depth of the feature point is represented by z, and an internal parameter of the image-capturing apparatus 10 is represented by K.

$${P}_{t - 1} = {z}_{t - 1} \cdot {K}^{- 1} \cdot {p}_{t - 1} \qquad ( 4 )$$

$${P}_{t} = {Δ R}^{T} \cdot ( {P}_{t - 1} - Δ P ) \qquad ( 5 )$$

$${p}_{t}^{′} = ( 1 / {z}_{t} ) \cdot K \cdot {P}_{t} \qquad ( 6 )$$

Note that the depth corresponds to zₜ₋₁, which is obtained using Formula (7) indicated below, where a Z coordinate of ΔR^{T}(zₜ₋₁K⁻¹pₜ₋₁−ΔP) is represented by zₜ.

$${p}_{t} = ( 1 / {z}_{t} ) \cdot K \cdot {Δ R}^{T} \cdot ( {z}_{t - 1} {K}^{- 1} {p}_{t - 1} - Δ P ) \qquad ( 7 )$$

[Step S103: Matching Processing]

The matching processor 122 reads, from the storage 124, an image patch that is stored in the storage 124, the image patch being situated around a feature point that is detected in a previous frame of a high-speed image. The matching processor 122 performs template matching that is searching for a region in a current frame of the high-speed image, the region being most similar to the read image patch, and detects, in a region obtained by the matching, a feature point that corresponds to the feature point in the previous frame (first matching processing). The matching processor 122 outputs location information regarding a location of the detected feature point to the weight calculator 123 and the depth calculator 125. The depth calculator 125 calculates a depth of each feature point detected by the matching processor 122, and outputs a result of the calculation to the storage 124.

[Step S104: Weight Calculation]

FIG. 5 schematically illustrates both a previous frame and a current frame of a high-speed image, and illustrates a method for calculating a moving-object weight of the current frame. The weight calculator 123 calculates a moving-object weight of a current frame of a high-speed image from an offset between a location of a feature point detected in the current frame and a prediction location, in the current frame, at which the feature point is situated.

Specifically, when a location of two-dimensional coordinates of the feature point detected in the current frame using the template matching is represented by pₜ, the weight calculator 123 calculates a distance Eₜ between the location pₜ of two-dimensional coordinates and the prediction location p′ₜ using, for example, Formula (8) indicated below.

[Math. 4]

εₜ=|pₜ−pₜ′| (8)

Next, the weight calculator 123 calculates a moving-object weight wₜ in the current frame using, for example, Formula (9) indicated below, where an arbitrary constant is represented by C. According to Formula (9) indicated below, the moving-object weight wₜ is closer to zero if εₜ is larger, and the moving-object weight wₜ is closer to one if εₜ is smaller.

$${W}_{t} = C / ( C + {ε}_{t} ) \qquad ( 9 )$$

[Step S105: Has Period of Time Corresponding to System Processing Rate Elapsed?]

When the image-capturing apparatus 10 has not performed image-capturing a specified number of times at a specified frame rate (when the number of exposures in a single frame is less than a predetermined number of times) (NO in Step S105), the image processing circuit 12 of the present embodiment repeatedly performs the series of processes of Steps S101 to S104 until image-capturing performed at a specified frame rate is completed.

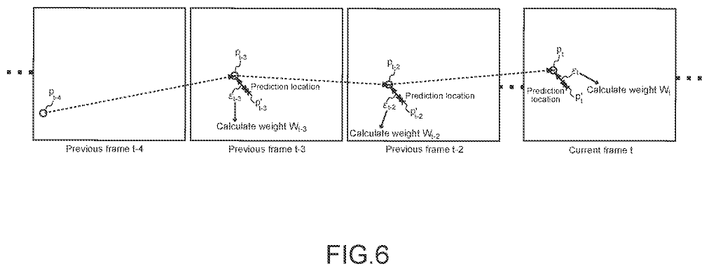

FIG. 6 schematically illustrates both a previous frame and a current frame of a high-speed image, and illustrates a process of repeatedly calculating a moving-object weight of a feature point detected in the previous frame.

In the process of repeatedly performing the processes of S101 to S104, the weight calculator 123 repeatedly calculates a moving-object weight Wₜ for a feature point detected in Step S103 described above, as illustrated in FIG. 6, and calculates an integration weight obtained by summing the calculated moving-object weights Wₜ. The weight calculator 123 outputs information regarding the calculated integration weight to the feature point sampling section 24.

On the other hand, when the image-capturing apparatus 10 has performed image-capturing the specified number of times at the specified frame rate (when the number of exposures in a single frame reaches the predetermined number of times), that is, when the matching processor 22 acquires a normal image from the image sensor 11 (YES in Step S105), the processes of and after Step S106 described later are performed.

[Step S106: Matching Processing]

From among high-speed images, the feature point detector 23 acquires a normal image that is output from the image sensor 11 at a specified output rate (for example, 60 fps). The feature point detector 23 detects a feature point in the normal image, extracts an image patch situated around the feature point, and writes the image patch in the storage 25.

The matching processor 22 reads, from the storage 25, an image patch that is stored in the storage 25, the image patch being situated around a feature point that is detected in a previous frame of the normal image. The matching processor 22 performs template matching that is searching for a region in a current frame of the normal image, the region being most similar to the read image patch, and detects, in a region obtained by the matching, a feature point that corresponds to the feature point in the previous frame (second matching processing). The matching processor 22 outputs location information regarding a location of the detected feature point to the feature point sampling section 24.

[Step S107: Sampling of Feature Points]

With respect to the feature points detected in the normal image, the feature point sampling section 24 removes an outlier using the integration weight acquired in Step S105 described above as a reference. Specifically, the feature point sampling section 24 samples the feature points, and performs a hypothesis verification. In the hypothesis verification herein, a tentative relative location and a tentative relative pose of the image-capturing apparatus 10 are obtained from a sampled pair of feature points, and whether a hypothesis corresponding to the tentative relative location and the tentative relative pose is correct is verified depending on the number of pairs of feature points having a movement relationship that corresponds to the tentative relative location and the tentative relative pose. The feature point sampling section 24 samples feature points a plurality of times. The feature point sampling section 24 determines that a pair of feature points having a movement relationship corresponding to a relative location and a relative pose of the image-capturing apparatus 10 that corresponds to a best hypothesis is an inlier pair, and a pair of feature points other than the inlier pair is an outlier pair, and removes the outlier pair.

In this case, according to a specified algorithm such as the progressive sample consensus (PROSAC) algorithm, the feature point sampling section 24 repeatedly performs processing that includes determining that a feature point for which an integration weight exhibits a small value is different from a feature point corresponding to a moving object; and preferentially performing sampling with respect to the feature point for which an integration weight exhibits a small value. This results in greatly reducing the number of sampling, compared to when feature points are randomly sampled from a normal image according to a normal algorithm that is the random sample consensus (RANSAC) algorithm, and results in significantly improving a processing speed that is necessary to estimate a location and a pose of the image-capturing apparatus 10 including the image sensor 11.

The feature point sampling section 24 outputs information regarding feature points sampled according to the PROSAC algorithm to the location-and-pose estimator 26. For the PROSAC, refer to Literature 1 indicated below (Literature 1: O. Chum and J. Matas: Matching with PROSAC—Progressive Sample Cocsensus; CVPR 2005).

[Step S108: Estimation of Location and Pose]

On the basis of an amount of an offset between a feature point in a previous frame and a feature point in a current frame that are sampled in Step S107 described above, the location-and-pose estimator 26 estimates a location and a pose of the image-capturing apparatus 10 including the image sensor 11 according to a specified algorithm such as the PnP algorithm. For the PnP algorithm, refer to Literature 2 indicated below (Literature 2: Lepetit, V.; Moreno-Noguer, M.; Fua, P. (2009), EPnP: An Accurate 0(n) Solution to the PnP Problem, International Journal of Computer Vision, 81(2) 155-166).

### Functions and Effects

Simultaneous localization and mapping (SLAM) is a technology used to estimate a self-location and a pose of an object, and a method using an inertial measurement unit (IMU) is often adopted to perform SLAM. However, in a system that primarily uses an IMU in order to estimate a self-location and a pose of an object using SLAM, observation noise is accumulated in process of performing integration processing on an acceleration and an angular velocity that are detected by the IMU, and the reliability of sensor data that is output by the IMU is ensured only for a short period of time. This may result in being unpractical.

Thus, a technology called visual inertial odometry (VIO) has been proposed in recent years, the visual inertial odometry estimating a self-location and a pose of an object with a high degree of accuracy by fusing odometry information and visual odometry, the odometry information being obtained by performing integration processing on an acceleration and an angular velocity that are detected by an IMU, the visual odometry tracking a feature point in an image captured by the object and estimating an amount of movement of the object using a projective geometry approach.

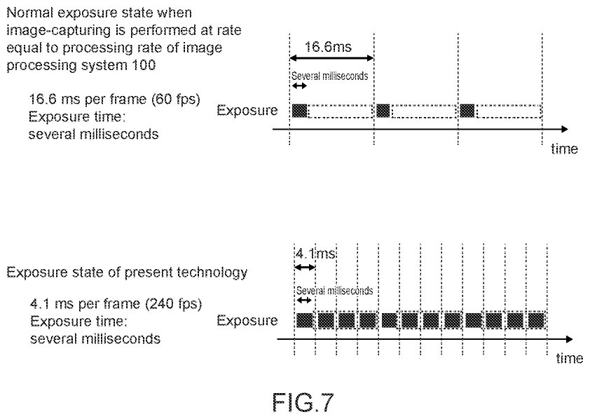

However, even using such a technology, a long exposure time makes it more difficult to detect a feature point due to a movement blur caused by the movement of a camera, and this may result in reducing the estimation accuracy. For the purpose of preventing such a reduction in estimation accuracy, the exposure time of a camera is generally limited to being short. In this case, the exposure time of a camera is very short, compared to when a normal rate of video output is adopted, as illustrated in FIG. 7, and a shutter is closed for most of an image-capturing period of time. FIG. 7 is a conceptual diagram illustrating both a normal exposure state when image-capturing is performed at a rate equal to the processing rate of the image processing system 100 and an exposure state of the present technology.

Further, when the SLAM technology is used, a self-location and a pose of an object are estimated on the assumption that there is no moving object in a captured image. Thus, there will be a reduction in estimation accuracy if a large number of moving objects appears on a screen. Therefore, according to the present embodiment, the image sensor 11 is caused to perform image-capturing at a higher rate than the processing rate of the image processing system 100 to improve the estimation accuracy, in order to effectively use the period of time for which the shutter is closed.

Specifically, the image sensor 11 generates a high-speed image by performing exposure at a high-speed frame rate for a period of time for which processing is performed at a frame rate of the image processing system 100. The image processing circuit 12 detects a feature point for each high-speed image, and, further, the image processing circuit 12 performs processing of calculating a moving-object weight of the detected feature point a plurality of times. In other words, a period of time for which a shutter is closed when image-capturing is performed at a normal image-capturing rate, is used as information regarding a plurality of frames due to image-capturing being performed at a high speed.

Consequently, processing of detecting, in a current frame of the high-speed image, a feature point that corresponds to a feature point detected in a previous frame of the high-speed image is performed a plurality of times in a short time span. This results in reducing an impact due to observation noise caused by the IMU 30, and results in improving the robustness of feature-point matching.

Further, the image processing circuit 12 of the present embodiment repeatedly calculates a moving-object weight for a feature point detected by the matching processor 122, and calculates an integration weight obtained by summing the moving-object weights obtained by the repeated calculation. Then, the image processing circuit 12 samples the feature points detected by the matching processor 22 on the basis of the integration weight.

This results in improving the robustness when sampling is performed with respect to a feature point that is from among feature points extracted from a normal image and is different from a feature point corresponding to a moving object. This makes it possible to increase the accuracy in estimating a self-location and a pose at a location at which there is a large number of moving objects.

### Modifications

The embodiments of the present technology have been described above. However, the present technology is not limited to the embodiments described above, and of course various modifications may be made thereto.

For example, in the embodiments described above, a feature point extracted from a captured image is weighted using the PROSAC algorithm using an integration weight as a reference. Without being limited thereto, a feature point may be weighted using, for example, a learning-type neural network used to weight a foreground (what can move) and a background in a captured image and to separate the foreground from the background. The following is an example of a network used to separate a foreground from a background. https://arxiv.org/pdf/1805.09806.pdf

### Others

Examples of the embodiment of the present technology may include the information processing apparatus, the system, the information processing method performed by the information processing apparatus or the system, the program causing the information processing apparatus to operate, and the non-transitory tangible medium that records therein the program, as described above.

Further, the present technology may be applied to, for example, a computation device integrated with an image sensor; an image signal processor (ISP) used to perform preprocessing a camera image; general-purpose software used to perform processing on image data acquired from a camera, a storage, or a network; and a mobile object such as a drone or a vehicle. The application of the present technology is not particularly limited.

Further, the effects described herein are not limitative, but are merely descriptive or illustrative. In other words, the present technology may provide other effects apparent to those skilled in the art from the description herein, in addition to, or instead of the effects described above.

The favorable embodiments of the present technology have been described above in detail with reference to the accompanying drawings. However, the present technology is not limited to these examples. It is clear that persons who have common knowledge in the technical field of the present technology could conceive various modifications or alterations within the scope of a technical idea according to an embodiment of the present technology. It is understood that of course such modifications or alterations also fall under the technical scope of the present technology.

Note that the present technology may also take the following configurations.

(1) An image-capturing apparatus, including

an image processing circuit that detects feature points for respective images of a plurality of images captured at a specified frame rate, and performs processing of calculating a moving-object weight of the detected feature point a plurality of times.

(2) The image-capturing apparatus according to (1), in which

the image processing circuit performs processing of extracting an image patch that is situated around the detected future point for each of the plurality of images.

(3) The image-capturing apparatus according to (2), in which

the image processing circuit performs first matching processing that includes searching for a region in a current frame of each of the plurality of images, the region corresponding to the image patch, and detecting, in the region, a feature point that corresponds to the feature point detected for each of the plurality of images.

(4) The image-capturing apparatus according to (3), in which

the image processing circuit
acquires sensor data that is obtained by an acceleration and an angular velocity of a detector being detected by the detector,
performs integration processing on the sensor data to calculate a location and a pose of an image-capturing section that captures the plurality of images, and
calculates a prediction location, in the current frame, at which the detected feature point is situated, on the basis of location information regarding a location of the detected feature point and on the basis of the calculated location and pose.
   (5) The image-capturing apparatus according to (4), in which

on the basis of the feature point detected by the first matching processing, and on the basis of the prediction location, the image processing circuit calculates a moving-object weight of the feature point detected by the first matching processing.

(6) The image-capturing apparatus according to (5), in which

the image processing circuit
calculates a distance between the feature point detected by the first matching processing and the prediction location, and
calculates the moving-object weight from the calculated distance.
   (7) The image-capturing apparatus according to (5) or (6), in which

the image processing circuit
repeatedly calculates the moving-object weight for the feature point detected by the first matching processing, and
calculates an integration weight obtained by summing the moving-object weights obtained by the repeated calculation.
   (8) The image-capturing apparatus according to (7), in which

the image processing circuit
performs processing that includes detecting a feature point in each of the plurality of images at a specified processing rate, and extracting an image patch that is situated around the feature point, and
performs second matching processing at the specified processing rate, the second matching processing including searching for a region in a current frame of each of the plurality of images, the region corresponding to the image patch, and detecting, in the region, a feature point that corresponds to the feature point detected at the specified processing rate.
   (9) The image-capturing apparatus according to (8), in which

on the basis of the integration weight, the image processing circuit samples the feature points detected by the second matching processing.

(10) An image processing system, including

an image-capturing apparatus that includes
an image processing circuit that
   detects feature points for respective images of a plurality of images captured at a specified frame rate, and
   performs processing of calculating a moving-object weight of the detected feature point a plurality of times.
      (11) An image processing method, including:
detecting, by an image processing circuit, feature points for respective images of a plurality of images captured at a specified frame rate, and
performing, by the image processing circuit, processing of calculating a moving-object weight of the detected feature point a plurality of times.
   (12) A program that causes an image processing circuit to perform a process including:
detecting feature points for respective images of a plurality of images captured at a specified frame rate, and
performing processing of calculating a moving-object weight of the detected feature point a plurality of times.

### REFERENCE SIGNS LIST

10 image-capturing apparatus
11 image sensor
12 image processing circuit
20 information processing apparatus
21 integration processor
22, 122 matching processor
23, 121 feature point detector
23, 121 feature point sampling section
25, 124 storage
26 location-and-pose estimator
30 IMU
100 image processing system
123 weight calculator
126 prediction location calculator

1. An image-capturing apparatus, comprising
an image processing circuit that
detects feature points for respective images of a plurality of images captured at a specified frame rate, and
performs processing of calculating a moving-object weight of the detected feature point a plurality of times.

2. The image-capturing apparatus according to claim 1, wherein
the image processing circuit performs processing of extracting an image patch that is situated around the detected future point for each of the plurality of images.

3. The image-capturing apparatus according to claim 2, wherein
the image processing circuit performs first matching processing that includes searching for a region in a current frame of each of the plurality of images, the region corresponding to the image patch, and detecting, in the region, a feature point that corresponds to the feature point detected for each of the plurality of images.

4. The image-capturing apparatus according to claim 3, wherein
the image processing circuit
acquires sensor data that is obtained by an acceleration and an angular velocity of a detector being detected by the detector,
performs integration processing on the sensor data to calculate a location and a pose of an image-capturing section that captures the plurality of images, and
calculates a prediction location, in the current frame, at which the detected feature point is situated, on a basis of location information regarding a location of the detected feature point and on a basis of the calculated location and pose.

5. The image-capturing apparatus according to claim 4, wherein
on a basis of the feature point detected by the first matching processing, and on a basis of the prediction location, the image processing circuit calculates a moving-object weight of the feature point detected by the first matching processing.

6. The image-capturing apparatus according to claim 5, wherein
the image processing circuit
calculates a distance between the feature point detected by the first matching processing and the prediction location, and
calculates the moving-object weight from the calculated distance.

7. The image-capturing apparatus according to claim 5, wherein
the image processing circuit
repeatedly calculates the moving-object weight for the feature point detected by the first matching processing, and
calculates an integration weight obtained by summing the moving-object weights obtained by the repeated calculation.

8. The image-capturing apparatus according to claim 7, wherein
the image processing circuit
performs processing that includes detecting a feature point in each of the plurality of images at a specified processing rate, and extracting an image patch that is situated around the feature point, and
performs second matching processing at the specified processing rate, the second matching processing including searching for a region in a current frame of each of the plurality of images, the region corresponding to the image patch, and detecting, in the region, a feature point that corresponds to the feature point detected at the specified processing rate.

9. The image-capturing apparatus according to claim 8, wherein
on a basis of the integration weight, the image processing circuit samples the feature points detected by the second matching processing.

10. An image processing system, comprising
an image-capturing apparatus that includes
an image processing circuit that
detects feature points for respective images of a plurality of images captured at a specified frame rate, and
performs processing of calculating a moving-object weight of the detected feature point a plurality of times.

11. An image processing method, comprising:
detecting, by an image processing circuit, feature points for respective images of a plurality of images captured at a specified frame rate, and
performing, by the image processing circuit, processing of calculating a moving-object weight of the detected feature point a plurality of times.

12. A program that causes an image processing circuit to perform a process comprising:
detecting feature points for respective images of a plurality of images captured at a specified frame rate, and
performing processing of calculating a moving-object weight of the detected feature point a plurality of times.
